(19) United States
(12) Patent Application Publication
(10) Pub. No.: US 2025/0004582 A1
(43) Pub. Date: Jan. 2, 2025

(54) HANDHELD INTERACTION DEVICE AND METHOD FOR CONFIGURING SUCH DEVICES

(71) Applicant: Ai2Ai Oy, Turku (FI)

(72) Inventors: Henrik Terävä, Turku (FI); Anton Ramsay, Turku (FI)

(73) Assignee: Ai2Ai Oy, Turku (FI)

(21) Appl. No.: 18/710,714

(22) PCT Filed: Feb. 10, 2023
(86) PCT No.: PCT/FI2023/050083

§ 371 Date: May 16, 2024

(30) Foreign Application Priority Data
Feb. 18, 2022 (FI) 20225147

(51) Int. Cl. G06F 3/038; G01L 5/22; G06F 3/0346; G06F 3/0354

(52) U.S. Cl. CPC G06F 3/038; G01L 5/22; G06F 3/0346; G06F 3/03547; G06F 2203/0384

(57) ABSTRACT

Disclosed is handheld interaction device with a housing providing shape and structure to a handheld interaction device, a battery configured to power the handheld interaction device, user-interface element(/s) arranged on an outer surface of the housing, detection sensors arranged on the housing and configured to collect detection sensor data, and a processor communicably coupled to memory. The processor is configured to: determine, using collected detection sensor data, an area on outer surface of the housing, which user is in contact with, when in use; and configure at least one of plurality of detection sensors, that is located outside of the determined area, as input sensor to receive interaction from user when in use.

### TECHNICAL FIELD

The present disclosure relates to handheld interaction devices. Moreover, the present disclosure also relates to methods for configuring a handheld interaction device.

### BACKGROUND

Along with the evolution of technology in our fast-paced world, there arose a need for interaction devices which allowed users to interact with machines. Slowly, such interaction devices transformed into hand-held devices which could be used for a variety of actions by engaging in interaction with and from a user. Such interaction devices facilitate users to interact with a computer for performing a variety of actions including calling, pinging, calculating, messaging, recording, utilizing a flashlight, and the like. Nowadays, such interaction devices have evolved into smart gadgets including smart watches, phones, pagers, tablets, and the like. Such available devices may be hand-held for portability and provide comfort of use to the user.

However, such interaction devices suffer from some limitations. Notably, the existing interaction devices can be held for use only in a specific pre-designed alignment. For example, as a smartphone may be held only with its screen side up for use. Moreover, sometimes such devices require a specific button to be pressed or a specific input to be provided in order to activate the device and utilize the same. In cases that the device is operated too quickly, or the button does not get properly pressed, the device does not get activated. Moreover, extra effort and time is required for the user to see the device and align it properly before use. This is often not practically possible in harsh conditions or emergency situations. In an example, if a miner is in a mine and requires immediate support, it is highly unlikely for the miner to be able to correctly orient the device for use in the darkness, and timely notify the authorities. In another example, if a person requires immediate medical attention, it is unlikely that the person would have the time or acuity to operate the device for calling an ambulance by orienting the device correctly.

Therefore, in light of the foregoing discussion, there exists a need to overcome the aforementioned drawbacks associated with automatic orientation and alignment of interaction devices.

### SUMMARY

The present disclosure seeks to provide a handheld interaction device. The present disclosure also seeks to provide a method for configuring a handheld interaction device. An aim of the present disclosure is to provide a solution that overcomes at least partially the problems encountered in prior art.

In one aspect, an embodiment of the present disclosure provides a handheld interaction device comprising:
a housing, wherein the housing provides shape and structure to the handheld interaction device;
a battery configured to power the handheld interaction device;
at least one user-interface element arranged on an outer surface of the housing;
a plurality of detection sensors arranged on the housing and configured to collect detection sensor data;
   and
a processor communicably coupled to a memory, wherein the processor is configured to:
   determine, using the collected detection sensor data, an area on the outer surface of the housing, which a user is in contact with, when in use; and
   configure at least one of the plurality of detection sensors, that is located outside of the determined area, as an input sensor to receive interaction from the user when in use.

In another aspect, an embodiment of the present disclosure provides a method for configuring a handheld interaction device, the method comprising:
detecting an area on an outer surface of the handheld interaction device, which is being touched by a user when the handheld interaction device is being held by the user;
configuring at least one detection sensor that is located outside of the detected area to function as an input sensor; and
collecting interaction information from the input sensor.

Embodiments of the present disclosure substantially eliminate or at least partially address the aforementioned problems in the prior art, and enable automatic activation and usability of handheld interaction devices for any alignment of such devices.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a schematic illustration of a handheld interaction device, in accordance with an embodiment of the present disclosure;

FIG. 2 illustrates a schematic illustration of a handheld interaction device, in accordance with another embodiment of the present disclosure;

FIG. 3 illustrates a schematic illustration of a handheld interaction device comprising a plurality of magnetic sensors and a plurality of magnets, in accordance with another embodiment of the present disclosure;

FIGS. 4A and 4B are exemplary schematic views (side view and top perspective view, respectively) of a handheld interaction device, in accordance with an embodiment of the present disclosure;

FIGS. 5A, 5B, 5C and 5D are exemplary schematic illustrations of a user holding a handheld interaction device, in accordance with an embodiment of the present disclosure;

FIGS. 6A and 6B are exemplary schematic illustrations of a handheld interaction device, in accordance with yet another embodiment of the present disclosure;

FIG. 7 illustrates a table of examples for determining plausible states of a handheld interaction device based on sensor data; and

FIG. 8 illustrates steps of a method for configuring a handheld interaction device, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a handheld interaction device comprising:
a housing, wherein the housing provides shape and structure to the handheld interaction device;
a battery configured to power the handheld interaction device;
at least one user-interface element arranged on an outer surface of the housing;
a plurality of detection sensors arranged on the housing and configured to collect detection sensor data;
   and
a processor communicably coupled to a memory, wherein the processor is configured to:
   determine, using the collected detection sensor data, an area on the outer surface of the housing, which a user is in contact with, when in use; and
   configure at least one of the plurality of detection sensors, that is located outside of the determined area, as an input sensor to receive interaction from the user when in use.

In another aspect, an embodiment of the present disclosure provides a method for configuring a handheld interaction device, the method comprising:
detecting an area on an outer surface of the handheld interaction device, which is being touched by a user when the handheld interaction device is being held by the user;
configuring at least one detection sensor that is located outside of the detected area to function as an input sensor; and
collecting interaction information from the input sensor.

The present disclosure provides the aforementioned handheld interaction device and the aforementioned method for configuring the handheld interaction device. Beneficially as compared to conventional devices, the user-interface element is arranged on the outer surface of the handheld interaction device, which enhances its visibility and makes the handheld interaction device accessible and easier for users to identify the controls and functions the handheld interaction device in practical use. Herein, the handheld interaction device detects an orientation of a user's hand and fingers while holding the handheld interaction device by way of the plurality of detection sensors. The plurality of detection sensors enables the handheld interaction device to perform a wider range of functions, such as detecting hand alignment, detecting gestures, detecting the orientation of the device irrespective of surrounding environmental conditions, and determining the position of the user's hand and fingers relative to the handheld interaction device sensors. As a result, the plurality of detection sensors enables the collection of a diverse range of data, providing an improved functionality and improved precision in recognizing user inputs on the handheld interaction device, for example, even in harsh operating conditions (e.g., in mines), or in emergency situations (e.g., in a medical emergency and the like). This increases the versatility and functionality of the handheld interaction device, making it more useful for a wider range of tasks and applications, such as navigation, fitness tracking, or playing games. At the same time sensors that provide output signal e.g., light and/or sound and which location is detected under the user's hand and/or fingers can be disabled to save power as those are neither visible nor hearable. The processor of the handheld interaction device identifies an area of the handheld interaction device in contact with the user's hand and fingers and activates an input sensor located out of said area to receive input from the user e.g., by using the other hand facilitating a tailored and customized interaction experience. By dynamically detecting the orientation of the user's hand, the handheld interaction device is dynamically activated such that the user is able to provide input, regardless of how the handheld interaction device is being held. In addition, the handheld interaction device is further configured to adapt the user's preferred way of holding the handheld interaction device. By virtue of adapting the user's preferred way of holding, the handheld interaction device eliminates the need for repeated calibrations. As a result, for future use cases, the user can provide input regardless of orientation of the handheld interaction device, enhancing the interaction's flexibility and ease-of-use for the user. This is advantageous for improving user experience in everyday life, and even in extreme and emergency situations. Such devices and methods considerably reduce the time and effort required by the user as the user is not required to orient the handheld interaction device in any particular manner or to provide any specific input for activation, and thus ensures ease of usability while also making user interaction faster than existing interaction devices. An additional technical effect provided by such an implementation is that of saving power and processor time by polling only sensors located outside of the detected area and not polling sensors within the determined area, e.g., sensors under the hand or sensors on the underside of the handheld interaction device when the handheld interaction device is placed on the surface such as a floor.

Throughout the present disclosure, the term “handheld interaction device” refers to a device which facilitates human interaction. The handheld interaction device is hand-held only during use. In an example, if a user holds the handheld interaction device to use the same, it will be considered hand-held. In another example, the handheld interaction device may be hand-held but still may not be in use. The handheld interaction device may not be hand-held when it is not in use. For example, when the handheld interaction device is kept on a surface, it may not be in use.

The housing is utilised as a casing for holding and safeguarding components of the handheld interaction device. Moreover, the housing is an integrated housing, such that all elements of the handheld interaction device are installed within the housing. Optionally, a shape of the housing is a three-dimensional symmetric shape. For example, the shape of the housing may be a cube, a sphere, a tetrahedron, an octahedron, a hexagonal polyhedron, and the like. Alternatively, optionally, a shape of the housing is a three-dimensional unsymmetrical shape. For example, the shape of the housing may be a cuboid, a cylinder, a prism, a pyramid, and the like. The housing allows the handheld interaction device to maintain its structural integrity. Optionally, the housing is made of an elastic material. In such a case, although the housing may get pressed under pressure, it will regain its form once the pressure is released. The housing may, for example, be made of an elastomer such as rubber. Alternatively, optionally, the housing is made of an inelastic material.

The battery is a source of electric power, which is used to power components of the handheld interaction device. Optionally, the battery is a disposable battery. In such a case, the battery can only be utilized for single use, and must be replaced with a similar battery. For example, the battery in a watch is often a disposable battery and must be replaced every few years. Examples of disposable batteries include, but are not limited to, zinc-carbon (Leclanché) batteries, alkaline zinc-manganese dioxide batteries, metal-air-depolarized batteries. Alternatively, optionally, the battery is a rechargeable battery. In such a case, the battery can be recharged and used multiple times. Examples of rechargeable batteries include, but are not limited to, lead-acid batteries, nickel-cadmium (NiCd) batteries, nickel-metal hydride (NiMH) batteries, lithium-ion (Li-ion) batteries, lithium-ion polymer (LiPo) batteries, rechargeable alkaline batteries. In some cases, the rechargeable battery is charged using a wire and an electricity outlet. In such cases, a port is provided in the housing to allow the wire to be connected with the battery. In other cases, the rechargeable battery is charged wirelessly. In the case where the battery may be charged wirelessly, at least one of: a visual feedback, an audio feedback, a haptic feedback, allows the user to adjust the handheld interaction device to a correct orientation for enabling wireless charging. Optionally, the battery is configured to operate in a power-saving mode. Herein, any sensors/elements which do not require to be in use at a given time are switched off (by controlling the battery to no provide power to them) in order to save power. Optionally, the handheld interaction device denotes a low battery warning using at least one of: a visual notification, an audio notification, a haptic notification.

The user-interface element refers to an element of the handheld interactive device which facilitates interaction with the user. Moreover, the user-interface element is configured to receive input from the user. For example, the at least one user-interface element may be a button, a touch screen, a force sensor, a biometric sensor, a microphone, and the like. Optionally, the at least one user-interface element includes a light-emitting component. Examples of a light-emitting component include, but are not limited to, a bulb, a light-emitting diode, a condensed fluorescent light, a liquid crystal display. Beneficially, the light-emitting component allows the user to identify the at least one user-interface element and interact with the same. Optionally, the at least one user-interface element is arranged symmetrically around the housing of the handheld interaction device. Herein, the at least one user-interface element is arranged symmetrically such that the user can easily access the at least one user-interface element and interact with the same from any portion of the handheld interaction device. Beneficially, this saves the user time and effort involved in turning the handheld interaction device to a particular side/portion to be able to access the at least one user-interface element.

Optionally, the at least one user-interface element is implemented as at least one button. Herein, the user may interact with the handheld interactive device by pressing the at least one user-interface element. For example, remote controls often have buttons to facilitate user interaction. Alternatively, optionally, the at least one user-interface element is implemented as at least one touch screen. Herein, the user may interact with the handheld interactive device by touching the at least one user-interface element.

Optionally, the at least one user-interface element is implemented as at least one microphone. Herein, the user may interact with the handheld interactive device by giving voice commands. Optionally, a plurality of microphones are comprised in the handheld interaction device. Herein, even if one microphone is covered, the audio input is clearly provided by at least one of other microphone(s). When a given microphone is covered (for example, by fingers of a user's hand when the handheld interaction device is in the user's hand) in a manner that audio input from the given microphone is blocked, then the given microphone is disabled, and the audio input comes through the other microphone(s) that is/are not covered. The covered microphone(s) may be detected with a detection sensor(s) or the input audio level may be measured and the microphone(s) providing better audio level signal is selected for use. A technical effect provided by such an implementation is that of saving power by not operating the given microphone and optional related audio amplifiers from which the audio input is blocked, which in turn elongates life of the battery of the handheld interaction device.

Throughout the present disclosure, the term “detection sensor” refers to a sensor which detects contact of the handheld interaction device with a surface. A plurality of detection sensors is arranged on the housing and configured to collect detection sensor data. As an example, the sensors can be arranged inside of the housing, on the surface of the housing or in other configuration such as some of the plurality of detections sensors are arranged on the surface of the housing and some are arranged inside of the housing of the handheld interaction device. Optionally detection sensors can refer to sensors which are located on an outer surface of the housing of the handheld interaction device. For example, if the handheld interaction device is held in a hand of the user, the plurality of detection sensors detect contact of the handheld interaction device with the hand of the user. In operation, the plurality of detection sensors sense which portion of the handheld interactive device is held by the user. Moreover, the plurality of detection sensors collect and send the collected detection sensor data to the processor. Optionally detection sensors can refer to sensors which are located inside of the housing of the handheld interaction device. Optionally, the plurality of detection sensors sense proximity of the handheld interaction device to the surface. Optionally, the plurality of detection sensors are arranged symmetrically throughout an outer surface of the housing. Symmetrically arranging the plurality of detection sensors is advantageous since the detection of contact can be done uniformly throughout the outer surface of the housing. Alternatively, optionally, the plurality of detection sensors are arranged randomly throughout the outer surface of the housing. Optionally, the sensor data is measured at reoccurring time intervals. For example, the sensor data may be measured for each sensor after every 10 seconds. In another example, the sensor data may be measured every second. Alternatively, optionally, the sensor data is measured at random time intervals. For example, the sensor data may be measured for each sensor after every second when the handheld interaction device is held in a hand of the user. In another example, the sensor data may be measured after 5 seconds when the handheld interaction device has stopped moving e.g., when placed on the surface such as a floor, and if not moving the sensor data may be measured in random intervals e.g., after 10, 6, 13, 19, 8, 27, etc. seconds.

Optionally, at least one of the plurality of detection sensors is implemented at least one of: a light sensor, a touch sensor, a button, a pressure sensor. In a case where at least one of the plurality of detection sensors is implemented as the light sensor, the at least one of the plurality of detection sensors utilize a beam of light to detect presence or absence of an object. Examples of light sensors include photovoltaic cell sensors, photodiode sensors, photo-resistor sensors, photo-transistor sensors, and the like. For example, the light sensor may detect the presence of the hand of the user on the handheld interaction device when its detection module does not receive any light (as it would be blocked by the hand). In operation, light sensors measure an intensity or luminance level of light to provide information pertaining to a direction that light may come from, or a space that the handheld interaction device may be placed within, or similar. For example, light sensors can detect if the handheld interaction device is kept in a box, such that the handheld interaction device may be kept inactive while it is kept in the box. Whenever the box is opened, an increase in light may activate the handheld interaction device for interaction with the user. In a case where at least one of the plurality of detection sensors is implemented as the touch sensor, the at least one of the plurality of detection sensors detect physical touch or proximity of touch. Examples of touch sensors include capacitive sensors, resistive sensors, and the like. For example, the touch sensor can detect the proximity of the hand of the user and activate the handheld interaction device. The capacitive sensors (i.e., capacitive pressure sensors) have two conductive layers separated by a dielectric. When the plurality of detection sensors are implemented as the capacitive sensors, the two conductive layers are moved closer to each other on pressing, which increases a capacitance, indicating a change in pressure. In a case where at least one of the plurality of detection sensors is implemented as the button, the at least one of the plurality of detection sensors would detect the presence of the hand of the user by being pressed. In operation, the button acts as a mechanical key and detects presence when it is pushed. For example, if the user is holding the handheld interaction device, the user may press the button such that the button detects the presence of the hand of the user. In a case where at least one of the plurality of detection sensors is implemented as the pressure sensor, the at least one of the plurality of detection sensors detect a pressure exerted on the handheld interaction device. This means that the plurality of detection sensors can measure how tightly the handheld interaction device is being held by the user. Examples of pressure sensors include Force Sensitive Resistor (FSR) sensors, capacitive pressure sensors, absolute pressure sensors, gauge pressure sensors, differential pressure sensors, and the like.

Optionally, the handheld interaction device comprises at least one accelerometer arranged inside of the housing and configured to detect the rotation and alignment of the handheld interaction device. The term “accelerometer” refers to an element which measures the vibration, or acceleration of motion of the handheld interaction device. The at least one accelerometer detects a rotation of the handheld interaction device in use by measuring orientation values and location values of the handheld interaction device in a three-dimensional coordinate structure (i.e., it measures the orientation values and location values in an x axis, a y axis, and a z axis). Optionally, the accelerometer is implemented as an alignment sensor. Herein, the accelerometer senses the alignment of the handheld interaction device. Examples of the accelerometer include but are not limited to a capacitive displacement sensor, an eddy-current sensor, a hall effect sensor. A technical advantage of this is that the accelerometer activates the handheld interaction device from a sleep or inactive mode that it may have been in. Beneficially, when more than one accelerometer is utilized in the handheld interaction device, the orientation values and location values are measured more accurately since the data being collected is increased. For example, when two accelerometers are utilized in the handheld interaction device, two datasets are generated pertaining to the location and alignment (i.e., orientation) of the handheld interaction device. Combining the two datasets provides a more accurate result that relying on merely one dataset.

Optionally, the handheld interaction device further comprises a gyroscope configured to measure rotation of the handheld interaction device. Optionally, the gyroscope comprises a spinning wheel or disc. Herein, the axis of rotation is free to assume any orientation by itself, indicating a change in the rotation of the handheld interaction device. Examples of the gyroscope include, but are not limited to a mechanical gyroscope, an optical gyroscope, a gas-bearing gyroscope. Advantageously, the gyroscope measures movement of the handheld interaction device when it is being rotated in the same position. Moreover, a technical advantage of using the gyroscope in the handheld interaction device is that gyroscope data provides insights pertaining to a more accurate orientation of the handheld interaction device than the at least one accelerometer. The at least one accelerometer is used to collect data related to linear acceleration and gravity, while the gyroscope is used to collect information about angular velocity. Therefore, such combination can be used to obtain accurate result in certain environmental conditions, irrespective of change in gravity (e.g., when the handheld interaction device is used by an astronaut while wearing a space suit). Therefore, the at least one accelerometer and the gyroscope, when implemented together, measure an accurate position and orientation of the handheld interaction device, even when the handheld interaction device is moving and rotating simultaneously. In addition, the combination of the at least one accelerometer and the gyroscope is beneficial to detect and respond quickly to complex movements, such as rotations in multiple axes and changes in speed.

Optionally, the handheld interaction device further comprises an air pressure sensor, wherein the air pressure sensor is configured to measure the change in height of the handheld interaction device. The term “air pressure sensor” refers to a sensor that detects air pressure (namely, atmospheric pressure). In operation, the air pressure sensor measures a height of the handheld interaction device, and/or a change in the height of the handheld interaction device, by detecting air pressure values and/or change in air pressure values. For example, a high air pressure indicates that the handheld interaction device is at a low height, and a low air pressure indicates that it is at a high height. Examples of the air pressure sensor include, but are not limited to an aneroid barometer sensor, a manometer sensor, a bourdon tube pressure sensor, a vacuum pressure sensor, a sealed pressure sensor, a micro-electromechanical systems (MEMS) device. The MEMS device senses air pressure changes in the handheld interaction device (the handheld interaction device may be hermetically sealed). When the air pressure sensor is implemented as the MEMS device, the air pressure sensor senses a change of air pressure inside the handheld interaction device when a force is applied to the handheld interaction device, which can be used to determine the force applied to the device. The air pressure sensor can also detect changes in air pressure and provide additional data for the processor, such as determining the altitude of the handheld interaction device, detecting changes in atmospheric pressure that may indicate weather patterns, or detecting the presence of air movement. A technical advantage of using the air pressure sensor in the handheld interaction device is that the air pressure sensor allows more accurate sensor fusion (by providing more sensor data pertaining to said device) and facilitates improved usability and improved accuracy of the handheld interaction device based on the sensor fusion, such as for navigation or fitness tracking.

Optionally, the handheld interaction device further comprises at least one of: a loudspeaker, a vibrator, a light-emitting diode. The loudspeaker provides an audio output pertaining to user interface generation and orientation, to the user of the handheld interaction device. Optionally, a plurality of loudspeakers are comprised in the handheld interaction device. Herein, even if one loudspeaker is covered, the audio output is clearly provided by at least one of other loudspeaker(s). When a given loudspeaker is covered (for example, by fingers of a user's hand when the handheld interaction device is in the user's hand) or placed on a surface (for example, when the handheld interaction device is placed on the surface such as a floor) in a manner that audio output from the given loudspeaker is blocked, then the given loudspeaker is disabled, and the audio output comes through the other loudspeaker(s) that is/are not covered. A technical effect provided by such an implementation is that of saving power by not operating the given loudspeaker from which the audio output is blocked, which in turn elongates life of the battery of the handheld interaction device. The loudspeaker of the handheld interaction device can be used in conditions related to safety hazards to provide audio alerts or warnings. For example, if the handheld interaction device is used in a situation where visibility is limited, such as in low light or during a power outage, then the loudspeaker can be used to provide audible navigation cues or instructions to help the user stay safe. The vibrator refers to an element which provides a vibratory motion to the handheld interaction device. In operation the vibrator provides a haptic output pertaining to kinaesthetic communications for interaction of the handheld interaction device with the user of the handheld interaction device, such as to differentiate between different types of inputs or interactions. For example, a different type of vibration can be used to indicate different types of notifications or alerts, such as incoming messages or calls. Optionally, the handheld interaction device comprises a plurality of vibrators. For example, if the handheld interaction device comprises two vibrators, one vibrator may be located at the top of the handheld interaction device and another vibrator may be located at the bottom of the handheld interaction device. A technical advantage of using the loudspeaker, the vibrator in the handheld interaction device is that they enable interaction of the handheld interaction device with the user by providing noticeable audio and haptic output, respectively. The light-emitting diode refers to an element which provides a visual (light-based) output pertaining to user interface generation and orientation, to the user of the handheld interaction device. Optionally, a plurality of light-emitting diodes are comprised in the handheld interaction device. Herein, even if one light-emitting diode is covered, the visual output is clearly provided by at least one of other light-emitting diode(s). More optionally, the plurality of light-emitting diodes may collectively act as a screen. Herein, the plurality of light-emitting diodes may provide text-based or graphic output on the screen. For example, the plurality of light-emitting diodes can be used to indicate the battery level or to indicate when certain functions or features are active. Additionally, the plurality of light-emitting diodes can be used to provide notification or alert indicators, such as flashing to indicate an incoming call or message. The use of the plurality of light-emitting diodes can provide the user with important information in a quick and easily understandable way, making it easier to use the handheld interaction device and interact with the various functions and features it provides. A technical effect provided by such an implementation is an immersive experience for the user since visual output is very impactful. A technical benefit of multiple light-emitting diodes being activated based on the hand orientation of the user is that of saving power. Beneficially, the loudspeaker, the vibrator, the light-emitting diode act as an output element. Such audio, visual and haptic output is beneficially immediately noticeable by the user. Moreover, such audio, visual and haptic output is noticeable by the user regardless of the orientation of the user's hand with the handheld interaction device, since the audio, visual and haptic output would be noticeable regardless of the orientation of contact between the user and the handheld interaction device. The handheld interaction device is increasing the likelihood that the user will receive and comprehend the information, even if they have limited ability to receive information through one or more of the modalities, regardless of the environment or the user's sensory abilities, such as individuals with hearing or vision impairments.

Optionally, the handheld interaction device further comprises an ultrawide band sensor, wherein the ultrawide band sensor is configured to measure distances between the handheld interaction device and another device. The ultrawide band sensor utilizes short-range, high-bandwidth communication for precisely detecting locations over a wide frequency range (from 3.1 GHz to 10.6 GHZ). In operation, this allows the handheld interaction device to precisely detect a location of another device, as well as the distance between them. For example, if the handheld interaction device is connected to a mobile phone of the user, the ultrawide band sensor may precisely detect a location of the mobile phone and a distance of the handheld interaction device from the mobile phone, allowing for seamless and improved data transfer to and from the mobile phone. A technical advantage of utilising the ultrawide band sensor in the handheld interaction device is that the ultrawide band sensor enables precise detection of the distance between the handheld interaction device and another ultrawide band enabled devices.

Throughout the present disclosure, the term “processor” refers to hardware, software, firmware, or a combination of these configured to control operation of the aforementioned handheld interaction device. In this regard, the processor performs several complex processing tasks. The processor is communicably coupled to other components of the handheld interaction device wirelessly and/or in a wired manner. In an example, the processor may be implemented as a programmable digital signal processor (DSP). In another example, the processor may be implemented via a cloud server that provides a cloud computing service. In some implementations, the processor is integrated with the handheld interaction device. In such implementations, the processor is physically coupled to the handheld interaction device (for example, attached via mechanical and electrical connections within the handheld interaction device). In other implementations, the processor is implemented separately from the handheld interaction device. When the processor is implemented within the handheld interaction device, a size of the processor is limited due to limitations in a size of the handheld interaction device. Although when the processor is implemented at the handheld interaction device, it leads to faster communication of data. However, when the processor is implemented separately, there are no size limitations, and a larger processor provides more powerful and quick processing as compared to a smaller processor.

It will be appreciated that processing data is stored at the memory. The memory may be a local memory that is integrated with the processor, may be an external memory, may be a cloud-based memory, or similar. The memory is utilised for storing data, including but not limited to battery data, user-interface element data, detection sensor data, machine learning algorithm data, accelerometer data, gyroscope data, magnetic sensor data, force sensitive resistor data, electromechanical film data, air pressure sensor data, loudspeaker data, vibrator data, and ultrawide band sensor data. Optionally, the processor sends the collected detection sensor data to another device. Herein, the memory is utilised for buffering the collected detection sensor data, often when the handheld interaction device is not connected to another device. When another device is connected to the handheld interaction device, the collected detection sensor data is provided to another device with timestamp information.

Since the plurality of detection sensors provide information pertaining to the contact and/or proximity of the user to the handheld interaction device, the processor utilizes the collected detection sensor data and determines the area on the outer surface of the housing in contact of the user by analysing a location of a given detection sensor with the detection sensor data provided by the given detection sensor. It will be appreciated that the area on the outer surface of the housing which is determined to be in contact with the user is referred herein as the “determined area”. For example, there may be two detection sensors on the handheld interaction device, such that a first detection sensor is at the top and a second detection sensor is at the bottom. Upon processing the collected detection sensor data, the processor may determine that the user is holding the handheld interaction device in a manner that an area around the second detection sensor may be in contact with the user's hand, and another area around the first detection sensor may not be in contact with the user's hand.

Moreover, when an area on the outer surface of the housing is not in contact with the user at a given time, the at least one of the plurality of detection sensors arranged therein is implemented as the input sensor. This means that the input sensor is utilized to receive inputs from the user as an interaction during use. Referring to the previous example, since the first detection sensor is not in contact with the user's hand while the handheld interaction device is being held by the user, the first detection sensor may be utilized to obtain inputs from the user as an interaction during use. For example, the user may touch or press the first detection sensor to provide an input to the handheld interaction device. A technical benefit of the handheld interaction device as described hereinabove is that it eliminates a need for the user to orient or align the handheld interaction device for use. This saves time and effort for the user, and is extremely beneficial during extreme or emergency situations.

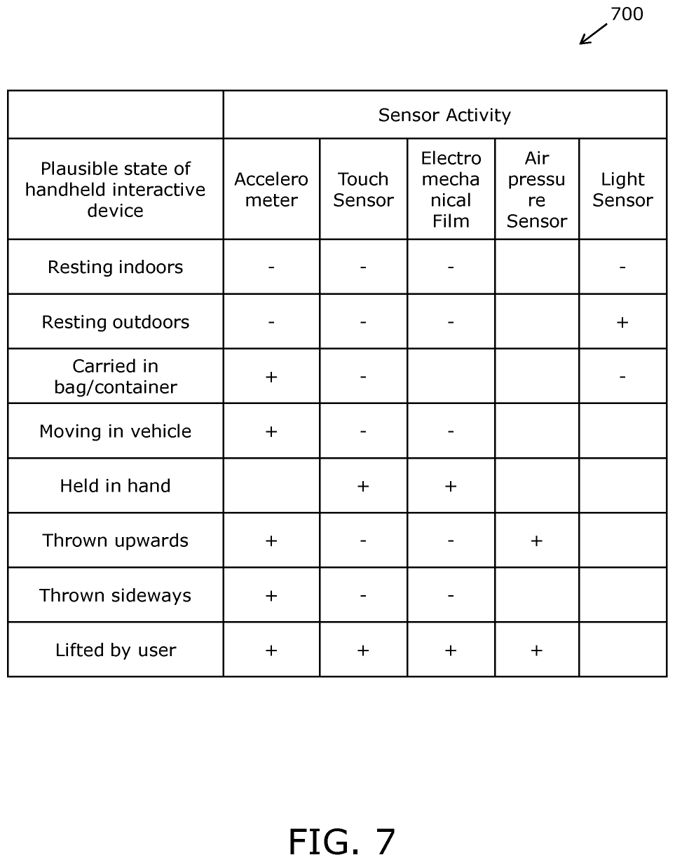

Optionally, the processor is configured to employ trained machine learning algorithm for operation of the handheld interaction device. The processor is configured to identify a plurality of plausible states according to activation and deactivation of the plurality of detection sensors in the handheld interaction device. The activation and deactivation of the plurality of detection sensors is indicated by an extent of sensor output from the plurality of detection sensors. In an implementation, specifically, the processor is configured to identify the plurality of plausible states according to activation and deactivation of the plurality of detection sensors in the handheld interaction device using the trained machine learning algorithm. In operation, the trained machine learning algorithm trains the processor to intelligently process data by providing training data as samples. The trained machine learning algorithm is run by the processor to determine contact of the handheld interaction device with the user using the collected detection sensor data. Examples of the trained machine learning algorithm include, but are not limited to, a linear regression algorithm, a logistic regression algorithm, a decision tree algorithm, a Support Vector Machine (SVM) algorithm, a naive bayes algorithm, a K-Nearest Neighbour (KNN) algorithm, a K-means algorithm, a random forest algorithm. In an implementation, in order to train a machine learning model (can also be referred to as a machine learning algorithm), historical training data of detection sensor data of a set of users, for example, about 10-100 users, may be provided as input. In an example, the training may use unsupervised deep learning without the need to label the training data. In another example, the training data may be labelled to detect at what time of day what kind of user interaction is performed with the handheld interaction device by a given user. Thus, a customised user specific interaction may be learned by the handheld interaction device over a period of time. Specially, the plurality of plausible states of the handheld interaction device may be learnt based on which sensors are activated and deactivated for a given time period in a given time of day. An example of the various plausible states is described in FIG. 7. Such plausible states may be used as parameters for training and learning of the machine learning model. This is how the machine learning model (i.e., the machine learning algorithm) is trained. Thus, the machine learning model is trained to identify the plurality of plausible states according to activation and deactivation of sensors indicated by an extent of sensor output from different sensors. For example, the plurality of plausible states of the handheld interaction device indicates that the handheld interaction device is, for example, resting indoors, resting outdoors, being carried in a bag or in a container, moving in a vehicle, held in a hand of a user, thrown in a specific direction, or being lifted by the user. The processor is further configured to correlate the plurality of plausible states of the handheld interaction device with usage pattern of the handheld interaction device specific to each user for a given time of day. Beneficially, the identification of the plurality of plausible states and additionally the correlation of the plurality of plausible states with usage pattern specific to each user for different times of day, enables improved functioning of the handheld interaction device itself. For example, advantageously, any false positive related to user interaction with the handheld interaction device is accurately avoided or significantly reduced by knowing the plausible states. For example, a user may be sick or shivering for some reason, and based on usage pattern, time of day, and identified plausible state, an accurate user interaction may be determined and recorded, and other sensor data caused due to shivering may be eliminated. In another example, the orientation of the hand of the user with respect to the handheld interaction device can be detected utilizing the trained machine learning algorithm. A technical advantage of utilizing the trained machine learning algorithm is that it assists the processor to easily identify trends and patterns in data and to make accurate determinations using said data, does not require human intervention, continuously improves with experiences (i.e., as it processes more and more data), and can have a variety of applications since it can handle multi-dimensional and multi-variety data. As the trained machine learning algorithm can continually learn and improve the performance of the handheld interaction device, thus the trained machine learning algorithm enables the handheld interaction device to adapt to the user's behaviour based on the collected data. Moreover, the trained machine learning model (or the machine learning algorithm) can be used to interpret large amounts of data to take more informed decisions with improved accuracy and efficiency.

Optionally, the processor is configured to activate the at least one user-interface element which is located outside of the determined area. A technical advantage of this is that it is easier for the user to interact with the at least one user-interface element which is located outside of the determined area, since the user would not be covering it (i.e., contacting it) while holding the handheld interaction device. Optionally, the processor activates a given user-interface element by activating the light-emitting component of the given user-interface element. In operation, when the light-emitting component of the given user-interface element is activated, the given user-interface element emits light. This indicates to the user that the user can now interact with the given user-interface element. A technical advantage of this is that it is easy for the user to interact with the user-interface element when it emits light, since it is easy for the user to detect the user-interface element. Optionally, the at least one user-interface element is activated based on an orientation of the user's hand with respect to the handheld interaction device. Herein, the at least one user-interface element is activated based on where a thumb or a finger of the user would naturally fall or can easily move, allowing easy interaction with the handheld interaction device for the user.

Optionally, the housing of the handheld interaction device is made from a flexible material. Examples of flexible materials include, but are not limited to graphene, polyvinyl chloride (PVC), graphite, fiberglass, polyethylene terephthalate, poly-methyl methacrylate (PMMA), polycarbonate, urethane, polytetrafluoroethylene (PTFE), rubber, polyether ether ketone (PEEK), neoprene. For example, the housing of the handheld interaction device is made from rubber. A technical advantage of making the housing from the flexible material is that it makes the handheld interaction device durable, such that it does not break easily and electrical components inside the handheld interaction device are protected. Another technical advantage is that the handheld interaction device is able to endure pressure without getting damaged. The housing of the handheld interaction device is developed and designed to withstand impacts and changes in temperature, humidity, and other physical conditions, making the handheld interaction device more suitable for use in a wider range of environments, especially in environments where the handheld interaction device may be subjected to shock or vibrations.

Optionally, the handheld interaction device comprises at least one magnetic sensor arranged inside of the housing and at least one magnet arranged on the outer surface of the housing and the processor is further configured to measure change of magnetic field of the at least one magnet to detect if the handheld interaction device is squeezed. The term “magnetic sensor” refers to a sensor which detects and measures magnetic fields. Examples of the at least one magnetic sensor includes, but is not limited to a hall sensor, a semiconducting magnetoresistor sensor, a ferromagnetic magnetoresistor sensor, a fluxgate sensor, a superconducting quantum interference device (SQUID) sensor, a resonant sensor, an induction magnetometer sensor, a linear variable differential transformer sensor, an inductosyn sensor, a synchro sensor, a resolver sensor. The magnetic field is produced by the at least one magnet arranged on the outer surface of the housing. Optionally, the at least one magnet is implemented as at least one of: a permanent magnet, a temporary magnet, an electromagnet. Since the housing of the handheld interaction device is flexible, when the handheld interaction device is pressed (for example, even slightly pressed by the action of holding the handheld interaction device), a position of the at least one magnet on the housing changes, causing a change in the magnetic field produced by the at least one magnet. The at least one magnetic sensor senses this change in the magnetic field. The at least one magnetic sensor provides magnetic sensor data to the processor, which processes the magnetic sensor data to detect a touch of the user's hand on the at least one magnet. A technical advantage of using the at least one magnetic sensor and the at least one magnet in the handheld interaction device is that it provides an accurate information of hand orientation, hand alignment (and additionally, optionally, of a user type, for example, adults, children, and the like) and finger presses of the user. Another technical advantage of this is that the magnetic sensor data can be utilized to activate the handheld interaction device. Yet another technical advantage of this is that the at least one magnetic sensor can detect other devices in a vicinity of the handheld interaction device based on magnetic fields of the other devices and/or how the other devices affect the magnetic field produced by the at least one magnet. The handheld interaction device can be used for various applications such as detecting the direction and intensity of the magnetic field, detecting metal objects, and detecting changes in the magnetic field.

Optionally, the handheld interaction device comprises at least one magnetic sensor arranged inside of the housing and at least one magnet arranged on the outer surface of the housing and the processor is further configured to measure change of magnetic field of the at least one magnet to detect an alignment of the user's hand. Optionally, the handheld interaction device comprises a plurality of magnetic sensors arranged inside of the housing and a plurality of magnets arranged on the outer surface of the housing. Optionally, the plurality of magnetic sensors and the plurality of magnets are arranged symmetrically, within and on the outer surface of the handheld interaction device. Optionally, a number of magnetic sensors arranged inside of the housing lies in a range of 1-20. More optionally, the number of magnetic sensors arranged inside of the housing lies in the range of 6-10. Optionally, a number of magnets arranged on the outer surface of the housing lies in a range of 1-20. More optionally, the number of magnets arranged on the housing lie in a range of 10-12. For example, a handheld interaction device may comprise 7 magnetic sensors arranged inside of the housing and 12 magnets arranged on the outer surface of the housing. Optionally, the handheld interaction device comprises at least one magnetic sensor, at least one magnet, at least one touch sensor and at least one accelerometer. Herein, sensor data from the at least one magnetic sensor, the at least one touch sensor and the at least one accelerometer is correlated via sensor fusion to provide a more accurate hand orientation of the user's hand, as compared to hand orientations provided individually by individual sets of magnetic sensor data, touch sensor data and accelerometer data.

Optionally, the handheld interaction device comprises at least one force sensitive resistor arranged on the inner surface of the housing and the processor is further configured to measure change of resistance from the at least one force sensitive resistor to detect if the handheld interaction device is squeezed. The term “force sensitive resistor” refers to a sensor which measures and/or detects a change in force by measuring a change in resistance therein. The force sensitive resistor (FSR) is built using two conductive layers separated by an insulator. When the at least one force sensitive resistor is pressed, a resistance value drops, which is indicative of (i.e., directly related to) an amount of force applied. Examples of the at least one force sensitive resistor include but are not limited to a shunt-mode force sensitive resistor, a thru-mode force sensitive resistor. A technical advantage of using the at least one force sensitive resistor in the handheld interaction device is that the at least one force sensitive resistor is small in size and can be easily integrated into the handheld interaction device. This allows the handheld interaction device to have a small size, increasing usability for the user. Another technical advantage is that the at least one force sensitive resistor is highly sensitive to force and can easily detect if the handheld interaction device is squeezed, so the at least one force sensitive resistor appropriately facilitates interaction when the handheld interaction device is squeezed. Optionally, the at least one force sensitive resistor is arranged inside of the housing of the handheld interaction device. Herein, when the handheld interaction device is pressed, the housing would be pushed inwards and exert force on the at least one force sensitive resistor. Optionally a force sensitive resistor can be replaced with a strain gauge wherein a force is applied to the strain gauge which changes the length of the traces etched onto it. A strain gauge can be arranged as a Wheatstone bridge and the difference of resistance indicates the bending force. The strain gauge can be calibrated to give a force with absolute values with highly accurate repeatability. A technical advantage is a further improved accuracy by using multiple sensors. The at least one force sensitive resistor and the at least one magnetic sensor can collectively detect a wider range of user inputs and movements, such as squeezing the handheld interaction device while holding it near the magnetic field. Therefore, such combination, enable new forms of interaction and control of the handheld interaction, such as squeezing to confirm a selection and moving near the magnetic field to change modes. Additionally, the at least one magnetic sensor is used to enhance the accuracy of the at least one force sensitive resistor, such as by compensating for variations in temperature and other environmental factors that can affect the resistance of the at least one force sensitive resistor.

Optionally, the handheld interaction device comprises an electromechanical film arranged on the outer surface of the housing and the processor is further configured to measure change of charge from the electromechanical film to detect if the handheld interaction device is squeezed. The “electromechanical film” refers to a thin, flexible film which can function as a sensor. The electromechanical film has a voided internal structure, such that when it is pressed, a thickness of the electromechanical film changes, thereby indicating pressure. A technical advantage is that the electromechanical film can easily detect if the handheld interaction device is squeezed, and this facilitate interaction between the handheld interaction device and the user. In an embodiment, the electromechanical film is arranged partially on the outer surface of the housing. In another embodiment, the electromechanical film is arranged on an entirety of the outer surface of the housing. Optionally, the electromechanical film is switched off when not required (i.e., during transportation or storage) to save power, elongating the longevity of the battery (i.e., the battery life). This allows the handheld interaction device to save power (i.e., having an elongated battery life) during long periods of inactivity and not be accidentally switched on (i.e., due to non-sensor outputs not caused by human interaction). Another technical benefit of using the electromechanical film is that it elongates the battery life since sensing changes in the magnetic field, equipping a retail package (having the handheld interaction device therein) with a magnet allows the handheld interaction device to be shipped to the user in a hibernation state and is activated as soon as the retail package is opened. As the electromechanical film is arranged on the outer surface of the housing, thus a wide range of input options are available to the user, beyond just touch and gestures. In addition, the at least one magnetic sensor arranged inside the housing is used to enhance the accuracy of the electromechanical film's measurements, by compensating for variations in temperature and other environmental factors. Therefore, the combination of the electromechanical film and the at least one magnetic sensor provide alternative inputs that can be used to control the device without physical contact, such as pressing on the device through protective clothing or detecting changes in a magnetic field. This can help reduce the risk of injury or contamination in dangerous situations, such as in industrial, medical emergency.

Optionally, the handheld interaction device comprises at least one accelerometer, a gyroscope, at least one magnetic sensor, at least one magnet, at least one force sensitive resistor, an electromechanical film, an air pressure sensor, a loudspeaker, a vibrator, a light emitting diode, a wireless communication network, an ultrawide band sensor. Herein, sensor data from the at least one accelerometer, the gyroscope, the at least one magnetic sensor, the at least one magnet, the at least one force sensitive resistor, the electromechanical film, and the air pressure sensor is correlated via sensor fusion to provide a more accurate hand orientation (and presence) of the user's hand, as compared to hand orientations provided individually by individual sets of sensor data. For example, the air pressure sensor detects variations in air pressure, the plurality of detection sensors detect presence of the user's hand around the handheld interaction device, the accelerometer (or, the gyroscope) detect a vertical movement, and so forth. A technical advantage of such sensor fusion is that sensor data from all sensors (as mentioned above), is combined to reduce errors and determine an accurate position and orientation of the handheld interaction device (for example, if the handheld interaction device is being raised/lowered by the user, or if it is moving inadvertently, since being in an elevator or tumbling around in a backpack does not cause the same combined sensor data as the user intentionally moving it does).

Optionally, the handheld interaction device further comprises a wireless communication network, wherein the wireless communication network is configured to provide communication for the handheld interaction device with an external device. Such communication is a wireless communication. A technical effect of using the wireless communication network in the handheld interaction device is that it allows the user to exploit functionality of the external device using the handheld interaction device. Optionally, the wireless communication network is implemented as at least one of: a wireless local area network (WLAN), a bluetooth network, a wireless fidelity network, a near-field communication network. Optionally, the external device is implemented as at least one of: a computer, a mobile phone, a tablet, a pager, a smart watch. For example, the wireless communication network enables wireless communication between the handheld interaction device and a mobile phone of the user. Optionally, the handheld interaction device further comprises a near-field communication tag. Beneficially, the near-field communication (NFC) tag enables the handheld interaction device to be utilized for payments.

The wireless communication network can work with the aforementioned sensors, such as the ultrawide band, the at least one force sensitive resistor, the at least one magnetic sensor, and the electromechanical film to provide improved functionality and user experience in the handheld interaction device. By connecting the handheld interaction device to the wireless communication network, the handheld interaction device can communicate with other devices and servers, such as for transmitting and receiving data as well as commands in real-time. This enables the handheld interaction device to respond to user inputs and provide feedback, such as displaying information on a screen or producing sounds on the external device. The aforementioned sensors in combination with the wireless communication network can also be used to control the handheld interaction device wirelessly, allowing the user to interact with the handheld interaction device from a distance. For example, pressing on the handheld interaction device through protective clothing can activate certain functions (e.g., calling) on the handheld interaction device, which can then be transmitted wirelessly to the external device (e.g., mobile phone) to perform the corresponding function.

Optionally, the handheld interactive device is inactive when it is not in contact with the user. For example, the handheld interactive device is disabled when the user throws it in the air (i.e., when the handheld interactive device is in a state of free fall), and is activated when contact with the user is detected again. This provides a technical benefit of saving power and making the battery last longer without the need of a recharge and/or replacement since power of the battery is not consumed when said device is disabled. Such state of free fall of the handheld interactive device is identifiable by the accelerometer and the gyroscope.

Optionally, the handheld interactive device is dynamically activated based on the orientation of the user's hand. This means that when the handheld interaction device is moved in the user's hand, different user-interface elements and/or detection sensors are activated based on the orientation of the user's hand at a given time. For example, if the hand-held interaction device has five user-interface elements, two user-interface elements may get activated in a first orientation of the user's hand with the handheld interaction device, and three user-interface elements may get activated in a second such orientation. Optionally, the processor processes the sensor data to classify the user. In this regard, the processor compares values of the sensor data, finds patterns in the values of the sensor data, correlates the values of the sensor data, and the like. For example, classifications pertaining to age, gender, user hand dominance, etc. are possible. In an example, the processor classifies the user as an old right-handed male, by processing the sensor data. Since the handheld interaction device is activated with the presence of touch, ideally of a user's hand, the handheld activation device remains inactive in storage spaces (even in compact storage spaces, for example, a handbag). It will be appreciated that the handheld interaction device, during an accidental event, may turn off most of the sensors. Such accidental event may include, but is not limited to, a free fall from a height, a roll on the ground. Additionally, such accidental event may be identified using the at least one accelerometer, the touch sensor, and the like. Consequently, the handheld interaction device saves power, thereby elongating a longevity of the battery (i.e., a battery life).

Optionally, the handheld interaction device is operable under harsh conditions. For example, the handheld interaction device may be operable in zero gravity, underwater, during diving, in a space craft with no gravity, in an emergency situation, in pitch darkness, and similar. For example, the handheld interaction device may be used by a miner within a mine. Optionally, the handheld interaction device is operable through layers of material. For example, an astronaut wearing a space suit may be able to operate the handheld interaction device easily. Optionally, the handheld interaction device is operable during movement. For example, an old person whose hand may be shivering can easily operate the handheld interaction device. Optionally, the handheld interaction device is utilized for gaming. For example, the handheld interaction may be utilized as a game controller. In an example, the handheld interaction device may be used as a game. Herein, a first user-interface element may be activated at a first time instant and when the user interacts with the first (activated) user-interface element, then a second user-interface element would get activated at a second time instant (that is later than the first time instant) for the user to interact with next, and so on. Beneficially, such game could be used as an activity to strengthen hand-eye coordination for children.

The present disclosure also relates to the method for configuring a handheld interaction device as described above. Various embodiments and variants disclosed above, with respect to the aforementioned first aspect, apply mutatis mutandis to the method.

Optionally, the method further comprises activating at least one user-interface element which is located outside of the detected area.

Optionally, in the method, the handheld interaction device is according to any of the embodiments described hereinabove.

Advantageously, the handheld interaction device is configured to adapt the user's preferred way of holding the handheld interaction device, thereby improving the user experience and practical utility of the handheld interaction device. Beneficially, the determination of the area on the outer surface of the housing, which a user is in contact with, when in use, provides a technical effect of adapting the user's preferred way of holding, which eliminates the need for repeated calibrations. As a result, for future use cases, the user can provide input regardless of orientation of the handheld interaction device, enhancing the interaction's flexibility and ease-of-use for the user. Moreover, the processor is further used to configure the at least one of the plurality of detection sensors to receive interaction from the user when in use, such as to determine the plausible states of the handheld interaction device. In addition, the data received from the plurality of detection sensors is used to continuously train the machine learning model and adapt to the user's behavior and preferences, making the handheld interaction device more responsive and efficient over time. Specially, the plurality of plausible states of the handheld interaction device may be learnt based on which sensors are activated and deactivated for a given time period in a given time of day. For example, if the at least one accelerometer, the touch sensor, the electromechanical film, and the light sensor provide a low amount of sensor data (i.e., an amount of sensor data less than a defined threshold), and the air pressure sensor is not used, it may be determined that the handheld interaction device is resting indoors. Moreover, such combination can be used to train the machine learning model for future uses. However, if the at least one accelerometer, the touch sensor, the electromechanical film and the air pressure sensor provide a high amount of sensor data (i.e., an amount of sensor data greater than a defined threshold), and the light sensor is not used, it may be determined that the handheld interaction device is being lifted by the user. As a result, the data received from the plurality of detection sensors can be used by the machine learning model to provide an improved functionality and improved precision in recognizing user inputs on the handheld interaction device, for example, even in harsh operating conditions (e.g., in mines), or in emergency situations (e.g., in a medical emergency and the like). In an example, a user may be sick or shivering for some reason, and based on usage pattern, time of day, and identified plausible state, an accurate user interaction may be determined and recorded, and other sensor data caused due to shivering may be eliminated.

### DETAILED DESCRIPTION OF THE DRAWINGS

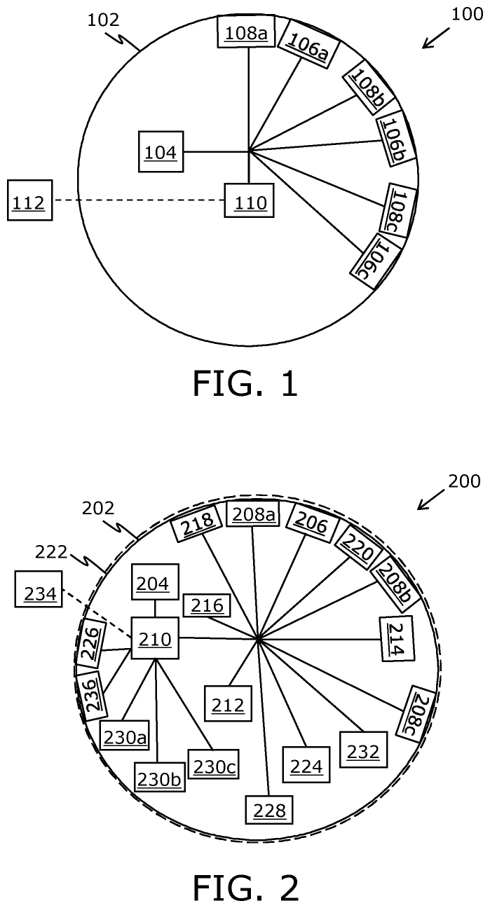

Referring to FIG. 1, illustrated is a schematic illustration of a handheld interaction device 100, in accordance with an embodiment of the present disclosure. The handheld interaction device 100 comprises a housing 102, a battery 104, at least one user-interface element (depicted as three user-interface elements 106a, 106b, 106c which are hereinafter collectively referred to as 106), a plurality of detection sensors 108a, 108b, 108c (hereinafter collectively referred to as 108), and a processor 110. The housing 102 provides shape and structure to the handheld interaction device 100. The battery 104 is configured to power the handheld interaction device 100. The at least one user-interface elements 106 are arranged on an outer surface of the housing 102, as shown in the figure. The plurality of detection sensors 108 are arranged on the housing 102 and configured to collect detection sensor data. The processor 110 is communicably coupled to the battery 104, the at least one user-interface element 106, and the plurality of detection sensors 108. The processor 110 is communicably coupled to a memory 112.

Referring to FIG. 2, illustrated is a schematic illustration of a handheld interaction device 200, in accordance with another embodiment of the present disclosure. The handheld interaction device 200 comprises a housing 202, a battery 204, at least one user-interface element 206, a plurality of detection sensors 208a, 208b, 208c (hereinafter collectively referred to as 208), a processor 210, at least one accelerometer 212, a gyroscope 214, at least one magnetic sensor 216, at least one magnet 218, at least one force sensitive resistor 220, an electromechanical film 222, an air pressure sensor 224, a loudspeaker 226, a vibrator 228, a wireless communication network 230, and an ultrawide band sensor 232.

The housing 202 provides shape and structure to the handheld interaction device 200. Moreover, the housing 202 is made from a flexible material. The battery 204 is configured to power the handheld interaction device 200. The at least one user-interface element 206 is arranged on an outer surface of the housing, as shown in the figure, and is activated by the processor 210. The plurality of detection sensors 108 are arranged on the housing 202 and configured to collect detection sensor data. The at least one accelerometer 212 is arranged inside of the housing and configured to detect the rotation and alignment of the handheld interaction device. The gyroscope 214 is configured to measure rotation of the handheld interaction device. The at least one magnetic sensor 216 is arranged inside of the housing 202 and the at least one magnet 218 is arranged on the outer surface of the housing 202. The at least one magnetic sensor 216 detects change of magnetic field of the at least one magnet 218 to identify if the handheld interaction device 200 is squeezed. The at least one force sensitive resistor 220 is arranged on the inner surface of the housing 202 and provides data pertaining to change of resistance to the processor 210 for enabling detection of if the handheld interaction device 200 is squeezed. The electromechanical film 222 is arranged on the outer surface of the housing 202 and detects a change of charge to identify if the handheld interaction device 200 is squeezed. The air pressure sensor 224 measures the change in height of the handheld interaction device 200. The wireless communication network 230 is configured to provide communication for the handheld interaction device 200 with an external device. The wireless communication network 230 is implemented as a wireless local area network (WLAN) 230a, a bluetooth network 230b, and a near-field communication network 230c. The ultrawide band sensor 232 measures distances between the handheld interaction device 200 and another device. The processor 210 is communicably coupled to the battery 204, the at least one user-interface element 206, and the plurality of detection sensors 208, the at least one accelerometer 212, the gyroscope 214, the at least one magnetic sensor 216, the at least one magnet 218, the at least one force sensitive resistor 220, the electromechanical film 222, the air pressure sensor 224, the loudspeaker 226, the vibrator 228, the wireless communication network 230, and the ultrawide band sensor 232. The processor 210 is communicably coupled to a memory 234. Moreover, the handheld interaction device 200 further comprises a light-emitting diode 236.

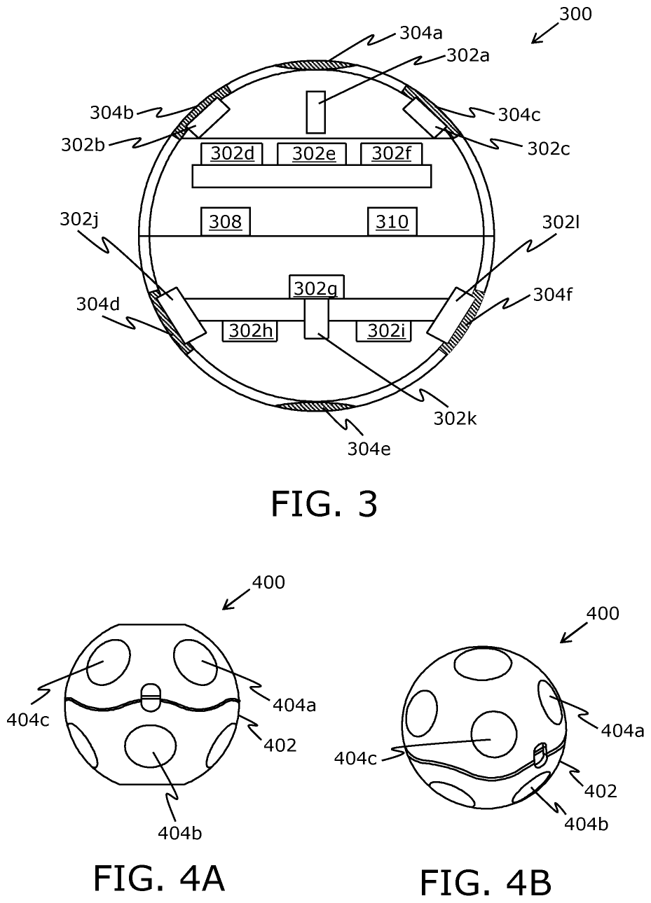

Referring to FIG. 3, illustrated is a schematic illustration of a handheld interaction device 300 comprising a plurality of magnetic sensors 302a 302b, 302c, 302d, 302e, 302f, 302g, 302h, 302i, 302j, 302k, 3021 (hereinafter collectively referred to as 302) and a plurality of magnets 304a, 304b, 304c, 304d, 304e, 304f (hereinafter collectively referred to as 304), in accordance with another embodiment of the present disclosure. The handheld interaction device comprises a housing 306, a battery 308, the plurality of magnetic sensors 302, the plurality of magnets 304, and a processor 310. The plurality of magnetic sensors 302 are arranged inside of the housing 306 and the plurality of magnets 304 are arranged on the outer surface of the housing 306. Herein, the processor 310 is configured to measure change of magnetic field of the plurality of magnets 304 by processing magnetic field data generated by the plurality of magnetic sensors 302 to detect if the handheld interaction device 300 is squeezed.

FIGS. 4A and 4B are exemplary schematic views (side view and top perspective view, respectively) of a handheld interaction device 400, in accordance with an embodiment of the present disclosure. The handheld interaction device 400 comprises a housing 402, and a plurality of user-interface elements 404a, 404b, 404c (hereinafter collectively referred to as 404). As shown, for example, the handheld interaction device 400 is spherical in shape. A user may interact with the handheld interaction device 400 by interacting with at least one of the plurality of user-interface elements 404.

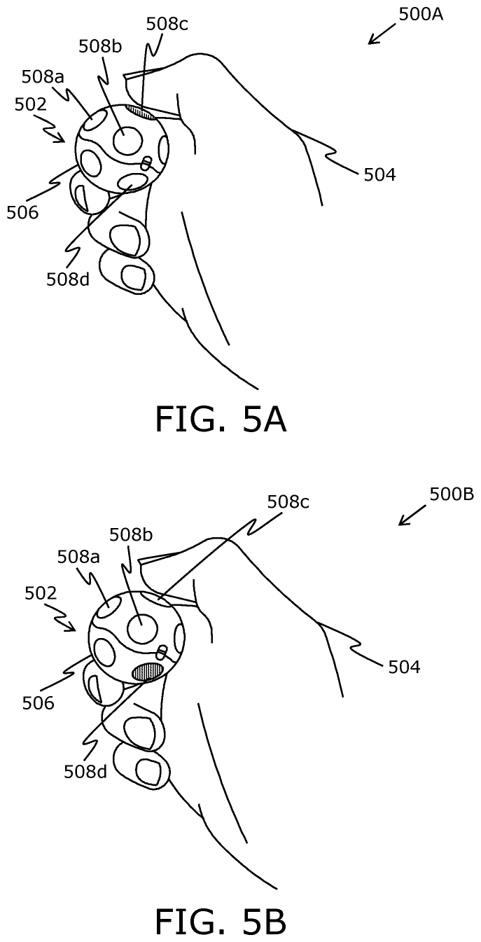

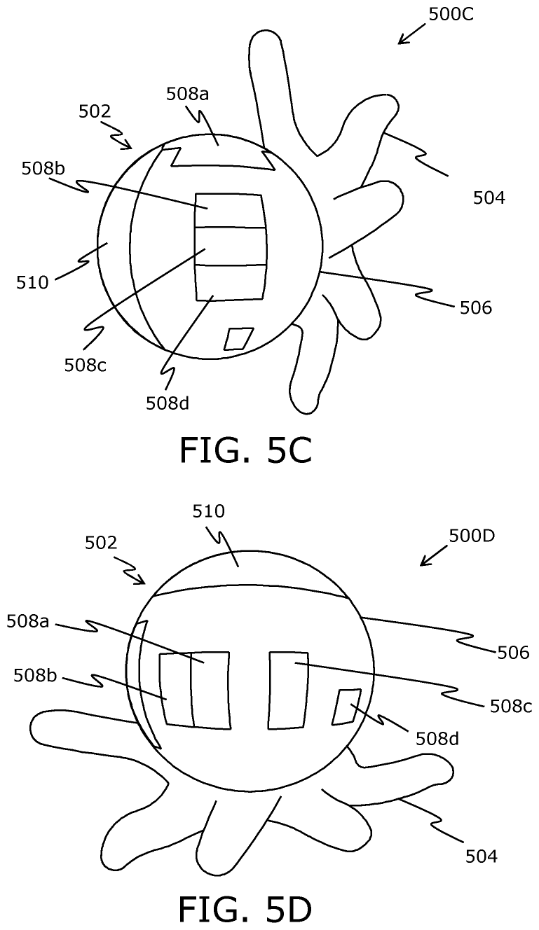

Referring to FIGS. 5A, 5B, 5C and 5D, illustrated are exemplary schematic illustrations 500A, 500B, 500C, 500D of a user holding a handheld interaction device 502, in accordance with an embodiment of the present disclosure. The handheld interaction device 502 is held by the user in a hand 504 of the user. The handheld interaction device 502 comprises a housing 506, and a plurality of user-interface elements 508a, 508b, 508c, 508d (hereinafter collectively referred to as 508). In FIG. 5A, a first user-interface element 508c is activated, based on an orientation of the hand 504 of the user. In FIG. 5B, when the handheld interaction device 502 is starting to be moved in the hand 504 of the user, a second user-interface element 508d is activated based on a changed orientation of the hand 504 of the user. In FIGS. 5C and 5D, the handheld interaction device 502 further comprises an output element 510 implemented as at least one of: a loudspeaker, a vibrator, a light emitting diode. Moreover, the handheld interaction device 502 is held in a palm of the hand 504 of the user, such that any elements (not shown) being covered by the hand 504 of the user are disabled. The plurality of user-interface elements 508 which the user can interact with are activated (corresponding to where each finger of the hand 504 of the user would lie), and the output element 510 is activated since it is visible to the user (i.e., not blocked by the hand 504 of the user). In FIG. 5C, the handheld interaction device 502 is held from a side by the user. In FIG. 5D, the handheld interaction device 502 is held from a bottom by the user.

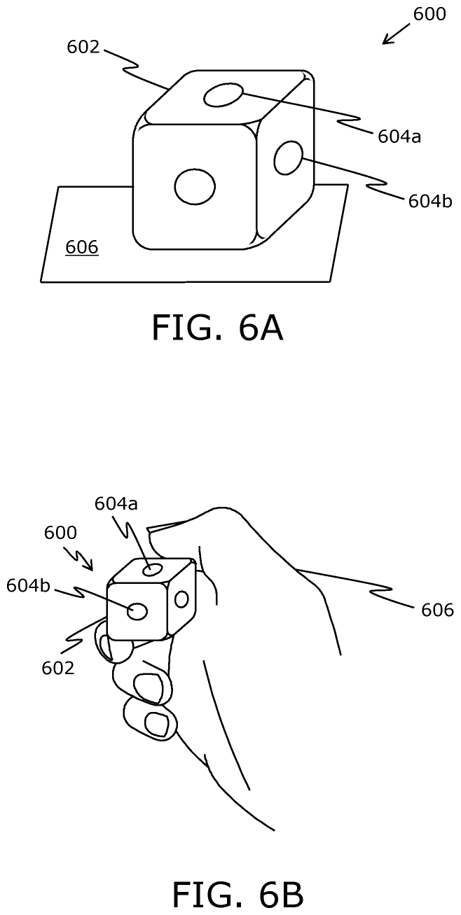

Referring to FIGS. 6A and 6B, illustrated are exemplary schematic illustrations of a handheld interaction device 600, in accordance with yet another embodiment of the present disclosure. The handheld interaction device 600 comprises a housing 602, and a plurality of user-interface elements 604a, 604b (hereinafter collectively referred to as 604). As shown, the handheld interaction device 600 is cubical in shape. In FIG. 6A, the handheld interaction device 600 is shown to be kept on a surface 606, and is in an inactive mode. In FIG. 6B, the handheld interaction device 600 is shown to be held in a hand 606 of a user, and is activated after detecting contact with the user.

It may be understood by a person skilled in the art that the FIGS. 1, 2, 3 4A, 4B, 5A, 5B, 6A and 6B are merely examples for sake of clarity, which should not unduly limit the scope of the claims herein. The person skilled in the art will recognize many variations, alternatives, and modifications of embodiments of the present disclosure.

Referring to FIG. 7, illustrated is a table 700 of examples for determining plausible states of the handheld interaction device, based on sensor data. The plausible states of the handheld interaction device are indicated on horizontal rows and the sensor data is indicated on vertical columns. A high sensor data is represented by “+” sign, a low sensor data is represented by “−” sign in the figure. Moreover, a blank cell (having no sign) represents that a given sensor is not being used for a respective determination. As shown in the figure, when the at least one accelerometer, the touch sensor, the electromechanical film and the light sensor provide a low amount of sensor data, and the air pressure sensor is not used, it may be determined that the handheld interaction device is resting indoors. When the light sensor provides a high amount of sensor data, the at least one accelerometer, the touch sensor, and the electromechanical film provide a low amount of sensor data, and the air pressure sensor is not used, it may be determined that the handheld interaction device is resting outdoors. When the at least one accelerometer provides a high amount of sensor data, the touch sensor, and the light sensor provide a low amount of sensor data, and the electromechanical film and the air pressure sensor are not used, it may be determined that the handheld interaction device is being carried in a bag or in a container. When the at least one accelerometer provides a high amount of sensor data, the touch sensor, and the electromechanical film provide a low amount of sensor data, and the air pressure sensor and the light sensor are not used, it may be determined that the handheld interaction device is being moved in a vehicle. When the touch sensor and the electromechanical firm provide a high amount of sensor data, and the at least one accelerometer, the air pressure sensor and the light sensor are not used, it may be determined that the handheld interaction device is held in a user's hand. When the at least one accelerometer and the air pressure sensor provide a high amount of sensor data, the touch sensor, and the electromechanical film provide a low amount of sensor data, and the light sensor is not used, it may be determined that the handheld interaction device is being thrown upwards. When the at least one accelerometer provides a high amount of sensor data, the touch sensor, and the electromechanical film provide a low amount of sensor data, and the air pressure sensor and the light sensor are not used, it may be determined that the handheld interaction device is being thrown sideways. When the at least one accelerometer, the touch sensor, the electromechanical film and the air pressure sensor provide a high amount of sensor data, and the light sensor is not used, it may be determined that the handheld interaction device is being lifted by the user.

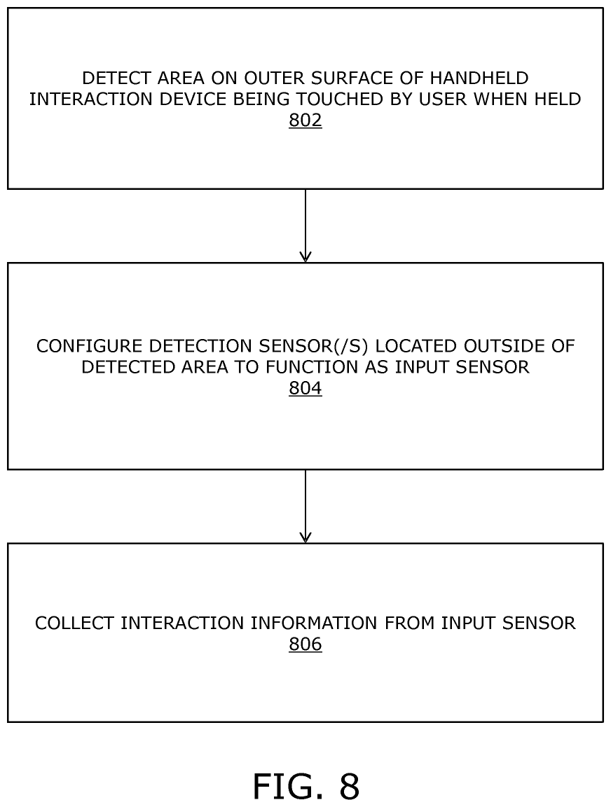

Referring to FIG. 8, illustrated are steps of a method for configuring a handheld interaction device, in accordance with an embodiment of the present disclosure. At step 802, an area on an outer surface of the handheld interaction device which is being touched by a user when the handheld interaction device is being held by the user is detected. At step 804, at least one detection sensor that is located outside of the detected area is configured to function as an input sensor. At step 806, interaction information is collected from the input sensor.

The steps 802, 804 and 806 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A handheld interaction device comprising:
a housing, wherein the housing provides shape and structure to the handheld interaction device;
a battery configured to power the handheld interaction device;
at least one user-interface element arranged on an outer surface of the housing;
a plurality of detection sensors arranged on the housing and configured to collect detection sensor data; and
a processor communicably coupled to a memory, wherein the processor is configured to:
determine, using the collected detection sensor data, an area on the outer surface of the housing, which a user is in contact with, when in use; and
configure at least one of the plurality of detection sensors, that is located outside of the determined area, as an input sensor to receive interaction from the user when in use.

2. The handheld interaction device of claim 1, wherein the processor is configured to employ trained machine learning algorithm for operation thereof.

3. The handheld interaction device according to claim 1, wherein the handheld interaction device comprises at least one accelerometer arranged inside of the housing and configured to detect the rotation and alignment of the handheld interaction device.

4. The handheld interaction device according to claim 1, wherein the processor is configured to activate the at least one user-interface element which is located outside of the determined area.

5. The handheld interaction device of claim 1, further comprising a gyroscope configured to measure rotation of the handheld interaction device.

6. The handheld interaction device of claim 1, wherein the housing of the handheld interaction device is made from a flexible material.

7. The handheld interaction device according to claim 6 wherein the handheld interaction device comprises at least one magnetic sensor arranged inside of the housing and at least one magnet arranged on the outer surface of the housing and the processor is further configured to measure change of magnetic field of the at least one magnet to detect if the handheld interaction device is squeezed.

8. The handheld interaction device according to claim 6 wherein the handheld interaction device comprises at least one force sensitive resistor arranged on the inner surface of the housing and the processor is further configured to measure change of resistance from the at least one force sensitive resistor to detect if the handheld interaction device is squeezed.

9. The handheld interaction device according to claim 6 wherein the handheld interaction device comprises an electromechanical film arranged on the outer surface of the housing and the processor is further configured to measure change of charge from the electromechanical film to detect if the handheld interaction device is squeezed.

10. The handheld interaction device of claim 6, further comprising an air pressure sensor, wherein the air pressure sensor is configured to measure the change in height of the handheld interaction device.

11. The handheld interaction device of claim 6, further comprising at least one of: a loudspeaker, a vibrator, a light emitting diode.

12. The handheld interaction device of claim 6, further comprising a wireless communication network, wherein the wireless communication network is configured to provide communication for the handheld interaction device with an external device.

13. The handheld interaction device of claim 6, further comprising an ultrawide band sensor, wherein the ultrawide band sensor is configured to measure distances between the handheld interaction device and another device.

14. A method for configuring a handheld interaction device, the method comprising:
detecting an area on an outer surface of the handheld interaction device, which is being touched by a user when the handheld interaction device is being held by the user;
configuring at least one detection sensor that is located outside of the detected area to function as an input sensor; and
collecting interaction information from the input sensor.

15. The method according to claim 14, wherein the method further comprises:
activating at least one user-interface element which is located outside of the detected area.

16. The method according to claim 14, wherein the handheld interaction device is according to claim 1.
